(19) United States
(12) Patent Application Publication
(10) Pub. No.: US 2002/0105312 A1
(43) Pub. Date: Aug. 8, 2002

(54) Charge pump based negative regulator with adjustable output current to allow reduction of switching noise

(76) Inventor: Jonathan Knight, Tokyo (JP)

Correspondence Address: TEXAS INSTRUMENTS INCORPORATED, P O BOX 655474, M/S 3999, DALLAS, TX, 75265

(21) Appl. No.: 10/052,974

(22) Filed: Oct. 29, 2001

Related U.S. Application Data
(60) Provisional application No. 60/253,504, filed on Nov. 28, 2000.

(51) Int. Cl. G05F 3/04

(52) U.S. Cl. 323/312

(57) ABSTRACT

A regulator circuit to output an adjustable output current includes an input current to input a switching signal to switch the regulator circuit and a switch circuit responsive to switching signal to switch the regulator circuit between a reduced current and a high current.

### FIELD OF THE INVENTION

The present invention relates to voltage regulator circuits. More particularly, the present invention relates to switching voltage regulator circuits.

### BACKGROUND OF THE INVENTION

The function of a voltage regulator is to provide a predetermined and substantially constant output voltage from an unregulated input voltage. Switching the regulator circuits typically uses a power transistor as a switch to provide a pulsed flow of current to a network of inductive and capacitive energy storage element switch which smoothes the switched current pulses into a continuous and regulated output voltage. Switching regulators can provide output voltages which are less than, greater than or of opposite polarity to an unregulated input voltage, depending on the mode of operation of a switching regulator. They can often be implemented to a large extent using integrated circuit components which advantageously reduce the size and complexity of the overall switching regulator circuit.

Switching regulators are commonly used in power supply circuits. Switching regulator power supplies generally can be classified into three categories depending on the output circuitry used. These are single ended inductor circuits, diode capacitor circuits and transformer coupled circuits.

### SUMMARY OF THE INVENTION

The present invention is compact with respect to boost size, is low in noise, and generates a negative voltage with a charge pump which reduces switching transients when a large current is not needed during the read mode. Additionally, the peak switching current is determined by the on resistance of transistors.

### BRIEF DESCRIPTION OF THE DRAWINGS

FIG. 1 illustrates a block diagram of the present invention;

FIG. 2 illustrates a more detailed description of the present invention;

FIG. 3 illustrates a side view of a system of the present invention; and

FIG. 4 illustrates a top view of the system of the present invention.

### DETAILED DESCRIPTION OF THE PRESENT INVENTION

The following invention is described with reference to figures in which similar or the same numbers represent the same or similar elements. While the invention is described in terms for achieving the invention's objectives, it can be appreciated by those skilled in the art that variations may be accomplished in view of these teachings without deviation from the spirit or scope of the invention.

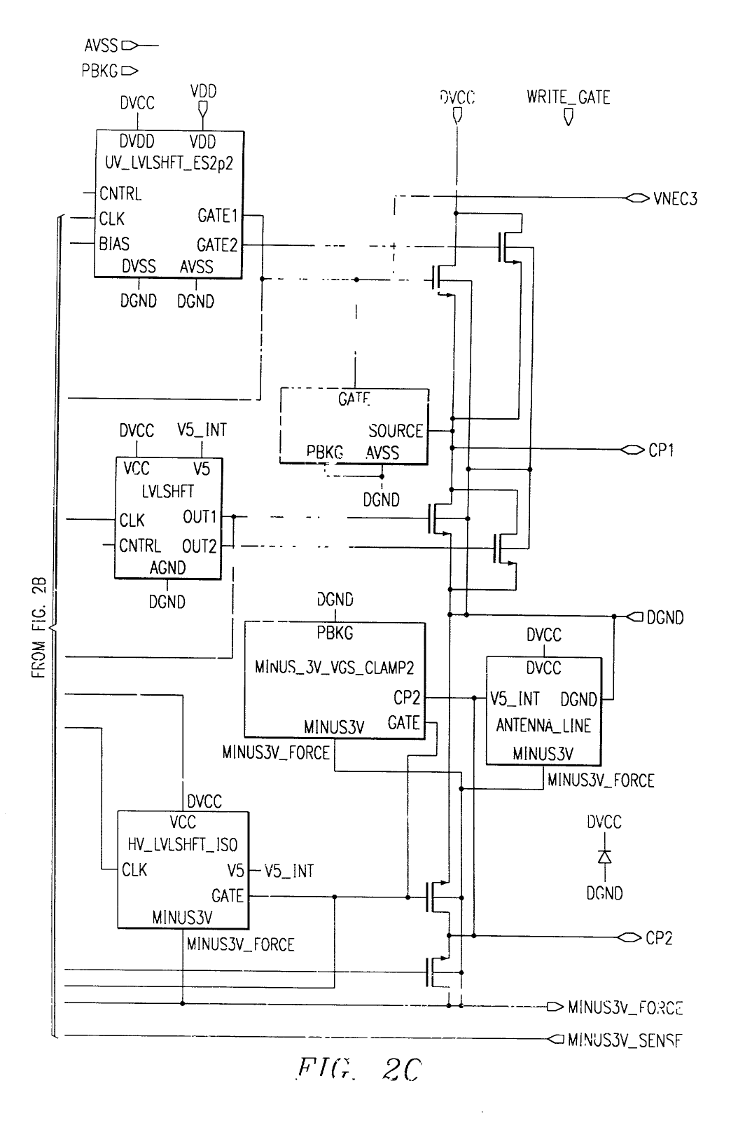

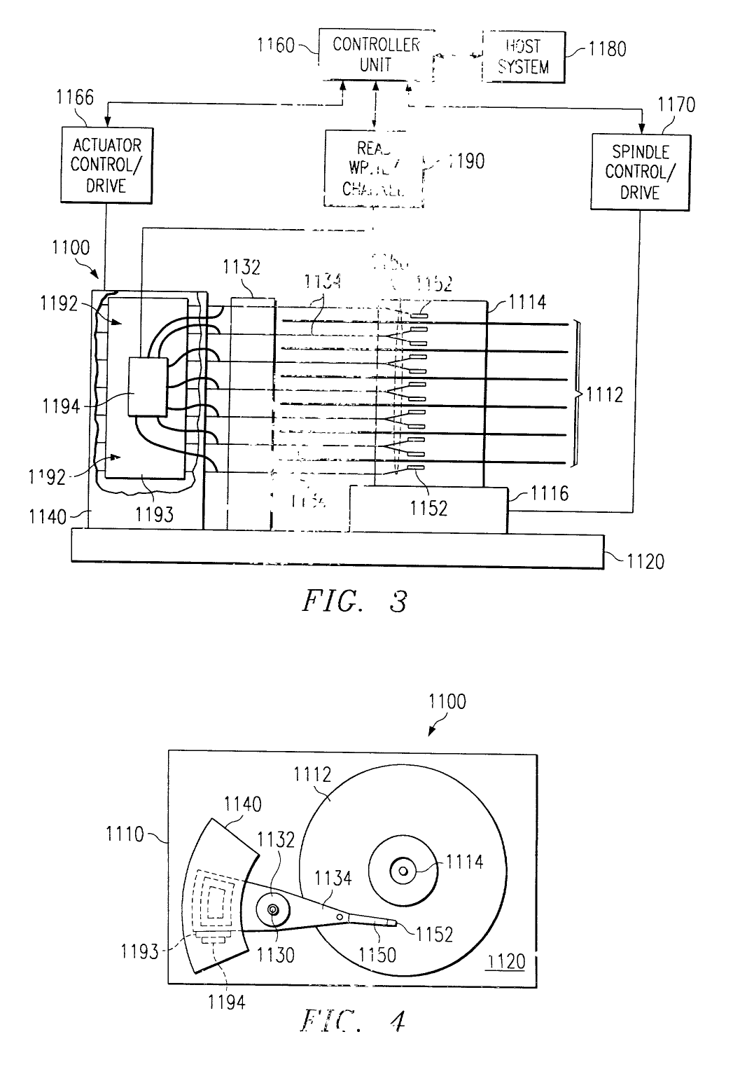

FIGS. 3 and 4 show a side and top view, respectively, of the disk drive system designated by the general reference 1100 within an enclosure 1110. The disk drive system 1100 includes a plurality of stacked magnetic recording disks 1112 mounted to a spindle 1114. The disks 1112 may be conventional particulate or thin film recording disk or, in other embodiments, they may be liquid-bearing disks. The spindle 1114 is attached to a spindle motor 1116 which rotates the spindle 1114 and disks 1112. A chassis 1120 is connected to the enclosure 1110, providing stable mechanical support for the disk drive system. The spindle motor 1116 and the actuator shaft 1130 are attached to the chassis 1120. A hub assembly 1132 rotates about the actuator shaft 1130 and supports a plurality of actuator arms 1134. The stack of actuator arms 1134 is sometimes referred to as a “comb.” A rotary voice coil motor 1140 is attached to chassis 1120 and to a rear portion of the actuator arms 1134.

A plurality of head suspension assemblies 1150 are attached to the actuator arms 1134. A plurality of inductive transducer heads 1152 are attached respectively to the suspension assemblies 1150, each head 1152 including at least one inductive write element. In addition thereto, each head 1152 may also include an inductive read element or a MR (magneto-resistive) read element. The heads 1152 are positioned proximate to the disks 112 by the suspension assemblies 1150 so that during operation, the heads are in electromagnetic communication with the disks 1112. The rotary voice coil motor 1140 rotates the actuator arms 1134 about the actuator shaft 1130 in order to move the head suspension assemblies 1150 to the desired radial position on disks 1112.

A controller unit 1160 provides overall control to the disk drive system 1100, including rotation control of the disks 1112 and position control of the heads 1152. The controller unit 1160 typically includes (not shown) a central processing unit (CPU), a memory unit and other digital circuitry, although it should be apparent that these aspects could also be enabled as hardware logic by one skilled in the computer arts. Controller unit 1160 is connected to the actuator control/drive unit 1166 which is in turn connected to the rotary voice coil motor 1140. A host system 1180, typically a computer system or personal computer (PC), is connected to the controller unit 1160. The host system 1180 may send digital data to the controller unit 1160 to be stored on the disks, or it may request that digital data at a specified location be read from the disks 1112 and sent back to the host system 1180. A read/write channel 1190 is coupled to receive and condition read and write signals generated by the controller unit 1160 and communicate them to an arm electronics (AE) unit shown generally at 1192 through a cut-away portion of the voice coil motor 1140. The AE unit includes the circuit of the present invention. The AE unit 1192 includes a printed circuit board 1193, or a flexible carrier, mounted on the actuator arms 1134 or in close proximity thereto, and an AE module 1194 mounted on the printed circuit board 1193 or carrier that comprises circuitry preferably implemented in an integrated circuit (IC) chip including read drivers, write drivers, and associated control circuitry. The AE module 1194 is coupled via connections in the printed circuit board to the read/write channel 1190 and also to each read head and each write head in the plurality of heads 1152.

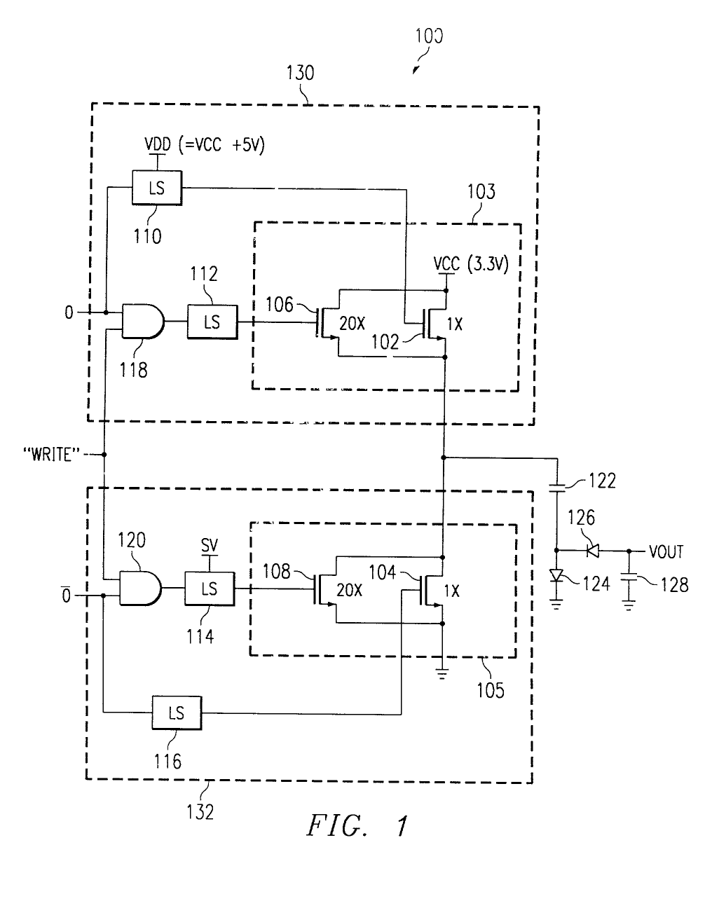

Turning now to FIG. 1, FIG. 1 illustrates a charge pump based switching regulator 100 with selectable output current capability. FIG. 1 illustrates a charge pump switching regulator 100 including a first section 130 and a second section 132. The first section 130 charges up the bucket capacitor 122 while the second section 132 discharges the bucket capacitor 122. The first section includes an AND gate 118 to accept the output from a clock circuit which is in this example a one megahertz clock signal Φ. The clock signal Φ is a series of pulses that have a frequency of one megahertz. Additionally, the AND gate 118 at another input accepts a write signal or switching signal to switch the switching regulator 100 from a first mode to a second mode from write to read and are used in connection with a read channel. The present invention is not intended to be used only in read channels, and other primary inputs instead of a write signal could be used with other types of circuits. The write signal can be used in conjunction with a preamplifier of a hard disk drive HDD. Additionally, the clock signal Φ is input to a level shifting circuit 110 to shift the clock signal from a first level to a second level. The output of the AND circuit 118 is connected to a level shifting circuit 112 to shift the output from the AND circuit 118 from a first level to a second level. The level shifting circuit 112 is connected to the gate of NFET 106. The output of level shifting circuit 110 is connected to the gate of NFET 102. NFET 106 is connected in parallel with NFET 102. The drain of NFET 106 is connected to the drain of NFET 102 and the source of NFET 106 is connected to the source of NFET 102. The source of NFET 106 and the source of NFET 102 are connected to one end of bucket capacitor 122. The bucket capacitor operates as a charge pump and AND circuit 118 and 120 are on the input circuit, NFET 102 and NFET 106 form a first switching circuit 103 and NFET 104 and NFET 108 form a second switching circuit 105.

The second section 132 is constructed in a similar fashion to the first section 130. The second section 132 operates in opposite phase with respect to the clock signal Φ to the first section 130 based upon inverse clock signal Φ. An AND circuit 120 is connected to receive the inverse clock signal \overline{Φ}. Another input of AND circuit 120 is connected to the input of AND circuit 118 and connected to read/write signal. The output of the AND circuit 120 is connected to a level shifting circuit 114. Additionally, another level shifting circuit 116 is connected to the input of AND circuit 120 to receive the inverse clock signal \overline{Φ}. The output of the level shifting circuit 116 is connected to the gate of NFET 104. The output of level shifting circuit 114 is connected to the gate of NFET 108.

The drain of NFET 108 and the drain of NFET 104 are connected together and connected to the source of NFET 106 and the source of NFET 102 and in addition are connected to one end of bucket capacitor 122. The sources of NFET 108 and the source of NFET 104 are connected together and connected to ground. The bucket capacitor 122 is connected to the input of diode 124 and the output of computation diode 126. Storage capacitor 128 is connected to the input of computation diode 126. Thus, with respect to NFET 106 and NFET 102, NFET 106 has an on resistance of approximately ½ of NFET 102 due to the fact that NFET 106 is twenty times as large as the NFET 102.

The same relationship exists between NFET 108 and NFET 104. The on resistance of NFET 108 is approximately 1/20 of the NFET. The on resistance of NFET 104 due to the size of NFET 108 being approximately 20 times the size of NFET 104. Thus, when NFET 106 or NFET 108 is turned on, the current that flows from the drain to a source increases dramatically due to the lower on resistance of NFET 106 to a high current. Thus, by controlling either NFET 106 or NFET 108, the output current from NFET 106 or NFET 108 can be controlled. More specifically, the voltage or bucket capacitor 122 either increases or decreases at a quicker rate when either NFET 106 or NFET 108 is turned on.

In operation, when the clock signal Φ has been received and no write signal has been received, the level shifter 110 level shifts the clock signal Φ to a level sufficient to activate NFET 102 by virtue of the connection to the gate of NFET 102. The current flows, with a reduced amount to bucket capacitor 122 through diode 124.

In contrast, when a write signal is received, the AND gate 118 outputs a signal to level shift 112. The signal is level shifted by a level shifter circuit 112 and activates NFET 106 by virtue of its connection. The on resistance of NFET 106 is greatly reduced with respect to NFET 102 and as a consequence, more current flows through NFET 106, and this increased current flows through bucket capacitor 122 and diode 124 to ground.

Likewise, second section 132 performs in the same way. More particularly, when only the inverse clock pulses \overline{Φ} are received by the AND circuit 120, only NFET 104 operates for a reduced current to float. The reduced current flows from storage capacitor 128 to bucket capacitor 122 through NFET 104. When the write signal has been received, a signal is generated from AND circuit 126 and is level shifted by level shifter circuit 114 to turn on NFET 108. Likewise, the reduced on resistance of the NFET 108 causes more current to flow along the same path associated with the description associated with NFET 104.

By operation of NFET 106 and NFET 108 with respect to the operation of NFET 102 and NFET 104 an adjustable output current is achieved.

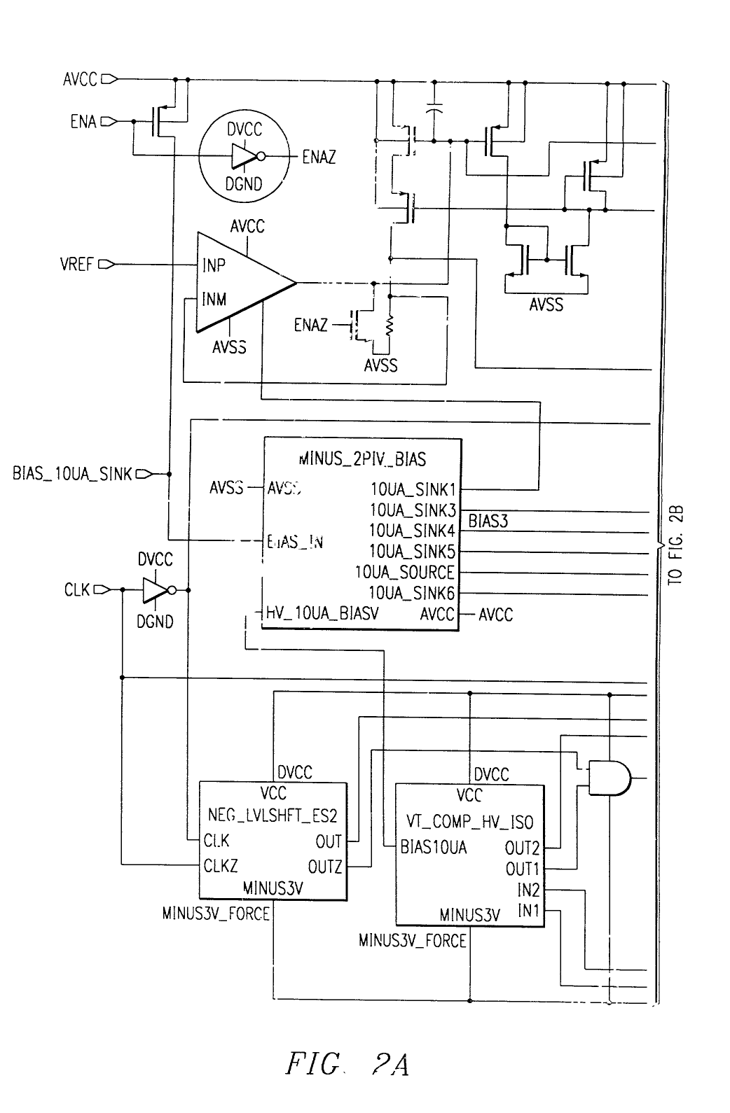

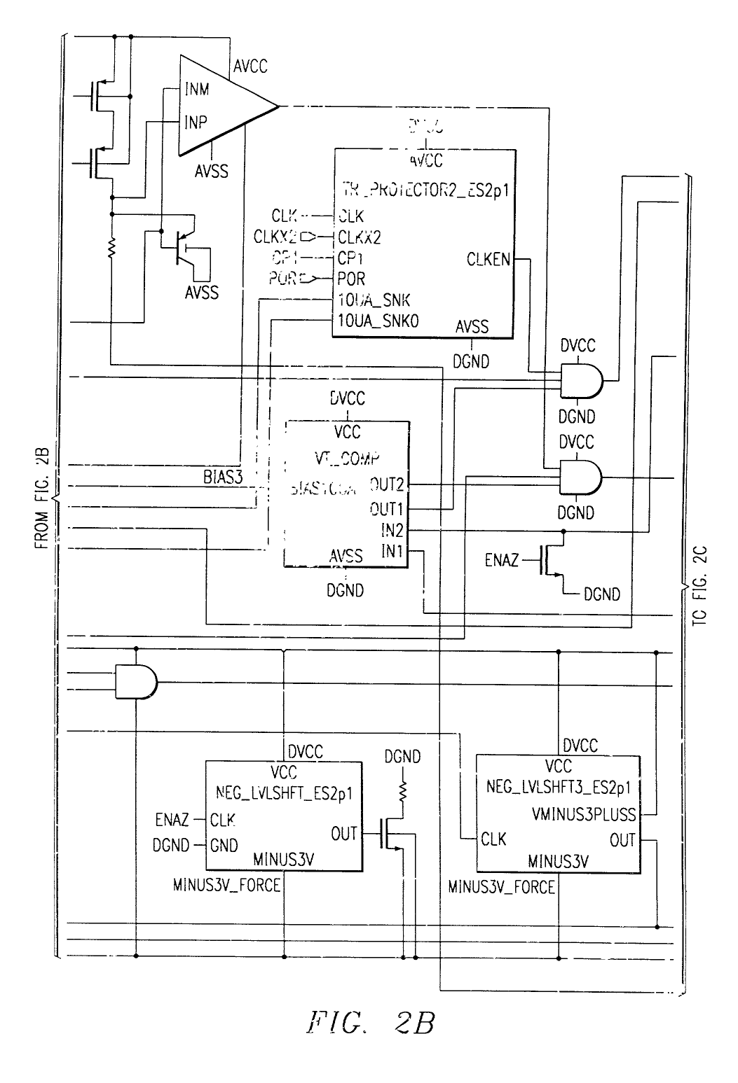

FIG. 2 illustrates an overall current diagram of the present invention.

1. A regulator circuit to output an adjustable output current; comprising:
an input current to input a switching signal to switch the regulator current;
a switch circuit responsive to switching signal to switch said regulator circuit between a reduced current and a high current.

2. A regulator circuit as in claim 1 wherein said switch circuit includes a FET to generate said high current.

3. A regulator circuit as in claim 1 wherein said switch circuit includes a FET to generate said reduced current.

4. A regulator circuit as in claim 2 wherein said FET is an NFET.

5. A regulator circuit as in claim 3 wherein said FET is an NFET.

6. A regulator circuit as in claim 3 wherein said regulator circuit includes a charge pump.

7. A regulator circuit as in claim 6 wherein said charge pump includes a capacitor.

8. A regulator circuit as in claim 6 wherein said switch circuit includes a first FET to generate said high current and second FET to generate said reduced current and said first FET has an on resistance greater that an on resistance of said second FET.
